(19) United States
(12) Patent Application Publication
(10) Pub. No.: US 2012/0183692 A1
(43) Pub. Date: Jul. 19, 2012

(54) PROTECTIVE COATING AND METHOD OF USE THEREOF

(76) Inventor: John C. BECKER, IV, Monson, MA (US)

(21) Appl. No.: 13/350,554

(22) Filed: Jan. 13, 2012

Related U.S. Application Data
(60) Provisional application No. 61/432,890, filed on Jan. 14, 2011.

(51) Int. Cl. C09D 175/04; B05D 3/02; B05D 3/00; C09D 179/02; C09D 175/02; B05D 1/02; C09D 201/06; B05D 1/28; B05D 3/12

(52) U.S. Cl. 427/289; 427/429; 427/428.01; 427/385.5; 427/331; 524/589; 427/427.4; 524/590; 524/612

(57) ABSTRACT

A protective coating for protecting a surface has a liquid applied coating having 100% solids and zero solvents and/or zero volatile organic compounds. The resulting protective coating may be clear or transparent to visible light. The liquid applied coating has two or more components that is applied to a surface as a liquid and cured in place to form a solid coating. The liquid applied coating may be cast onto a surface after mixing and spread on the surface to a final desired thickness. The liquid applied coating has a polyurea or polyurethane, or a hybrid polyurea-polyurethane. The polymeric resin system may have dendrimers or hyperbranched polyol or polyamine raw materials in the formulation. The protective coating optionally contains no polyaspartic amines.

### CLAIM OF PRIORITY

This application claims priority to U.S. Provisional Application No. 61/432,890, filed on Jan. 14, 2011, the disclosure of which is incorporated by reference herein.

### FIELD OF DISCLOSURE

The present disclosure is directed toward protective coatings and methods of use of the protective coatings. The disclosure is also directed toward methods for applying a protective coating to a substrate.

### BACKGROUND

The value of protective coatings is well established in industrial and non-industrial settings for a variety of applications. Transparent or clear coatings allow the underlying qualities of a given substrate to be viewed. The presence of a protective coating provides a barrier that prevents direct contact of objects or elements with the substrate which is often not durable enough to withstand repeated or sustained contact. There are a large number of applications using clear protective coatings in our environment today, one example being the coating of wood floors with single component polyurethane.

Polyurethane coatings are generally either waterborne or solventborne and therefore rely on drying either in ambient or elevated temperature conditions. In addition, the resin or polymer is carried in the water or solvent generally at a 30% to 50% resin solids level which requires time and/or energy for removal to reach the final dried coating layer. Further, water or solvent borne coating systems possess a lower crosslink density, necessitated by the requirement of the water and/or solvents to leave the coating thickness through the process of volatilization or evaporation. Shrinkage of the dried coating after application is also of concern in these systems.

When solventborne coatings are used, there may be release of the carrier solvent into the atmosphere which is harmful to the environment and may be harmful to the user. When waterborne coatings are used, there may be release of co-solvents, volatile species of surfactants or other harmful residuals that are carried into the atmosphere with the evaporating water or water vapor and which is harmful to the environment.

### SUMMARY

In order to overcome the problems associated with the conventional methods above, the present disclosure is directed to a protective coating which eliminates the use of solvent or the use of volatile organic solvents in the application of the protective coatings.

In one embodiment, the protective coating is a liquid applied 100% solids protective coating having zero solvent and zero volatile organic compounds. The resulting protective coating may be clear or transparent to visible light.

In another embodiment, the protective coating is a liquid applied 100% solids protective coating having zero volatile organic compounds. The resulting protective coating may be clear or transparent to visible light.

In other embodiments, the liquid applied coating comprises a two or more component reactive system that is applied to a surface as a liquid and cured in place to form a solid coating. The liquid applied coating may be cast onto a surface after mixing and spread on the surface to a final desired thickness.

The polymeric resin system comprising the liquid applied coating can be a polyurea or polyurethane, or a hybrid polyurea-polyurethane. The polymeric resin system can use dendrimers or hyperbranched polyol or polyamine raw materials in the formulation.

The materials presented in the current disclosure may be comprised of 100% solids. In certain embodiments, there are no carrier solvents or water present in the materials used to manufacture the coating while in other embodiments, there are no carrier solvents or water present in the materials used to manufacture the coating nor during the application of the coating. These materials are liquids prior to and during mixing and prior to gelation. The materials of the current disclosure may react, once mixed, in a specific period of time dictated by the given application method and the formulation to yield a solid durable polymer film. The liquid components of the current disclosure may employ zero or near zero volatile organic compounds (VOCs).

The materials of the current disclosure can be applied to the desired surfaces by any suitable means of applying materials to a surface. For example, the materials may be applied by casting, brushing, rolling, spraying, and the like.

After application of the materials, and after a period of time sufficient to allow solidification of the materials to form a polymer film, the materials of the current disclosure may be abraded or buffed using well known abrasive products in industry. In some embodiments, the materials can be reduced in thickness near the coating termination points gradually to a near zero thickness. The gradual reduction in thickness resulting in a lack of a well defined termination point at, for example, an edge of the coating is particularly advantageous in preventing collection of unsightly dirt and debris.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the description is to be regarded as illustrative in nature, and not as restrictive.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or techniques have been described at a relatively high-level, without detail, in order to avoid unnecessarily obscuring aspects of the present teachings.

The current disclosure provides materials and processes for generating clear transparent protective coatings on any substrate using 100% solids having zero or near zero VOC coating fluids. The liquid applied coatings of the current disclosure are generally two component systems where a first component (A Side) and a second component (B Side) are mixed just prior to coating application. During and after mixing, the first component and second component react together to form a mixed coating material. In certain embodiments the first and second components may be monomers which can react with each other to form a polymer. For example, the first component may be a diisocyanate alkyl compound and the second component may be a diamine alkyl compound. When mixed, the diisocyanate alkyl compound and the diamine alkyl compound may react to form a polyurea compound.

After mixing the two components, the coating can then be applied by several methods including casting, rolling, brushing, squeegeeing, and spraying. In one embodiment, a post curing process step is added to enhance the appearance of the final protective coating layer. In some embodiments, the majority of the coating is applied at a thickness that maximizes depth of gloss appearance (>3 mil) and the thickness at the trailing edge is reduced in thickness to near zero through buffing, abrading or controlled spraying. As a result of the above-described process, high quality automotive coatings can be obtained. The post-curing process step may also be applied to any other uses where protective coatings are used, such as furniture, housing, musical instruments and the like.

Some polymeric resin systems disclosed in the current disclosure include polyurea and hybrid polyurea-urethane systems. Each of these systems can be applied using fluids that contain zero solvent. Accordingly, the release of hazardous VOCs into the atmosphere may be significantly reduced or eliminated. In addition, each of the systems in the current disclosure yield clear transparent hard protective coatings intended to enhance the durability of a specified substrate. In some embodiments, the polyurea resin system yields an optically clear film with >99.5% transmittance and less than 100 micro-bubbles per square foot of 1 mil diameter or greater.

Certain examples of polymeric resin systems presented in the present disclosure include polyol and polyamine raw materials used as the second component or the B Side of a material formulation. The present application discloses that polyurea and hybrid polyurea-polyurethane systems that do not depend on polyaspartic (aspartic ester) polyamine raw materials. Polymers formed from these non-polyaspartic polyureas and hybrid polyurea-polyurethane systems provide adequate working or open times. An adequate working or open time is defined as the required time elapsed from when the two or more components of the material are mixed together, transferred by various methods to the substrate to be coated, applied onto that substrate, and allowed to wet out the substrate completely and self level to a smooth finish coating film.

Materials disclosed in the present application can be applied by traditional coating methods including casting, rolling, brushing, spraying, use of squeegees and the like. Selection of a suitable application step may result in the prevention of bubbles, streaks and debris from appearing in the coating to yield high quality clear coatings.

In some embodiments, a low pressure two component cartridge or two component transfer pump system may be used to mix and apply the coating. The low pressure cartridge system utilizes a two piston pneumatic dispensing gun that forces two fluids to mix in a static mixer. The mixed coating may then be pushed out through a nozzle for application to the desired surface.

The cure rate of the materials disclosed in the present application may be accelerated through the application of heat following the coating deposition and spreading process. Application of heat may yield a hard durable coating. The coating may be further abraded or buffed to achieve even higher functionality and enhanced appearance. In some examples when heat is applied, the curing temperature greater than ambient temperature and is less than or equal to 150 F. However, any temperature sufficient to cure the coating, including ambient temperature may be used.

In some embodiments, cure rate acceleration or deceleration may be achieved by varying the ratio of the NH 1420 to the NH 1520 on the B Side. A greater ratio of the NH1420 to the NH1520 will increase the reactivity of the system and increase the cure rate while a lower ratio of NH1420 to NH 1520 will decrease the reactivity of the system and thereby decrease the cure rate. If the cure rate is reduced, too much sagging will occur on the vertical surfaces of the substrate. Such sagging may be controlled with well known rheological agents and anti-sagging materials. However, care needs to be exercised when selecting such materials to maintain clarity and translucency of the cured film.

In some embodiments, the final coating thickness is in the range of 1 mil to 200 mil or greater. In other embodiments the final coating thickness is in the range of 3 mil to 50 mil.

The abrading and buffing process in some embodiments of the present disclosure may be for use with the current materials of well known products from the coating industry. In some embodiments, a post curing abrasion process is employed comprising mechanically abrading the coated surface, typically known as “wet sanding” followed by buffing. One drawback found in precut film products used in the automotive industry for leading edge and impingement protection is a collection point for dirt and debris which occurs from a thick (>1 mil) termination point or edge of a film coating. Another drawback found in the precut film products used in the automotive industry for leading edge and impingement protection is their method of adhesion, which is a pressure sensitive adhesive (PSA). This PSA remains tacky at the cut edge of the film which may bond dirt and debris to that cut edge. To overcome these drawbacks, one abrasion process of the present disclosure results in a coating that gradually approaches near zero thickness at the coating termination point. The termination points of the coating are reduced in thickness gradually to a thickness of less than 1.0 mil or near zero thickness. The thickness of the coating can be reduced from the average coating thickness to near zero thickness over a distance of at least 500 mil. The lack of a well defined thick termination point yields a coating edge that will not be collection point for dirt and debris and the coating edge has no adhesive edge to bond dirt and debris. Furthermore, as a result of the coating process, any damaged areas resulting from use can be repaired without removing the original coating in areas outside the damaged area.

In some examples, the polyurea in the coating resin system may be prepared using an isocyanate to amine index of less than 1.00. In this example, the term index refers to a ratio of Side A equivalent weight to the Side B equivalent weight where the two are reactants, such as isocyanate and amine. However, any ratio of isocyanate to amine may be used that results in a coating sufficient to protect a substrate.

### EXAMPLES

### Example 1

Clear Protective Coating—A 100% solids clear protective coating was formulated and applied to a surface as shown below in Table 1. Side A and Side B were mixed in a 1:1 volume ratio for two minutes to form coating material. Side A included an aliphatic polyisocyanate based trimer. Side B included an aspartic ester amine and a polyisocyanate crosslinker. The coating material was then cast onto the surface and rolled out using firm closed cell polyurethane foam rollers to achieve a coating with a thickness of 10 mil. The coating was allowed to cure overnight. The coating was then wet sanded and buffed with a cutting/polishing abrasive over the entire surface to achieve a “Class A” type of finish. Then the coating was again wet sanded and buffed near one edge such that the coating thickness gradually decreased from 10 mil cast thickness in the center of the coating down to a thickness of <1 mil. The edge of the coating was then buffed to a thickness of 0.1 mil. Then the entire surface that had not been buffed was buffed to achieve a “Class A” type of finish and consistent gloss level. The resulting coating had an end point that, due to its gradual reduction in thickness, was very difficult to distinguish.

TABLE 1

| Trade name | Manufacturer | % of side A or B | generic name |
|---|---|---|---|
| Side A | | | |
| N3600 | Bayer | 64.57% | Aliphatic Polyisocyanate based Trimer |
| Airthane API-470 | COIM | 23.80% | Aliphatic Polyisocyanate based Trimer |
| Propylene Carbonate | Huntsman | 11.63% | Carbonate Ester Reactive Diluent |
| | | 100.00% | |
| Side B | | | |
| NH1520 | Bayer | 24.87% | Aspartic Ester Amine |
| NH1420 | Bayer | 39.29% | Aspartic Ester Amine |
| Aldimine | Degussa | 23.81% | Polyisocyanate Crosslinker |
| 1,4-Butanediol | Lyondell | 4.11% | Isomeric reactive diluent |
| Incozol 2 | Incorez | 2.11% | Mono oxazolidine moisture scavenger |
| Perenol E8/EFKA 2722 | Cognis/BASF | 1.06% | Air Release Agent |
| SIA 0591.0 | Gelest | 1.90% | organosilane |
| Fumed Silica | EVONIK | 2.86% | Anti Sag Additive |
| | | 100.0% | |

### Example 2

The coating of Example 1 was applied to a surface using a two component pneumatic cartridge gun. Side A and Side B were loaded into cartridges and assembled for delivery through a static mixer to form a coating material. The coating material was mixed in real time through the static mixer and delivered to the surface via spraying to form a polyurea coating on the surface. The coating was then rolled and treated as in Example 1 to form the final protective coating. In field applications of vehicles which have been in service for over 18 months, the coating demonstrated its ability to protect the surface of the vehicle while retaining its clarity. An embodiment of Example 1 at 10 mils has been tested pursuant to ASTM test method C501-04 for Abrasion Resistance with a 200 gram load using CS-17 wheels. The test result showed a 0.72% weight loss. An embodiment of Example 1 at >60 mils was tested pursuant to ASTM test method D638-10 for Tensile Strength. The test results showed an average result over 5 specimens of 6240 psi.

### Example 3

The coating material of Example 1 was cast onto a surface and rolled out to 10 mil thickness. The wet coating was exposed to infrared heat lamps such that the surface temperature was elevated to a temperature range of about 130 F to about 150 F. The coating was cured sufficiently and fully set in 60 minutes to allow the abrading and buffing treatments described in Example 1 to be employed which generated a final coating that gradually is reduced in thickness at one edge to less than 0.1 mil thickness.

### Example 4

The coating of Example 1 was applied to a surface using a HVLP (High Volume Low Pressure) Gravity Fed gun commonly used in the automotive coating industry (Central Pneumatic Model Professional #43430 mfd in China). Side A and Side B were mixed together first and then poured into the cup. The cup was then affixed to the gun at the designated place. The coating material was sprayed using a 2.3 mm tip at 40 psi to form a polyurea coating on the surface. The coating wet out the surface and self-leveled to form the final protective coating.

### Example 5

The coating of Table 2 below was applied to a surface using a HVLP (High Volume Low Pressure) Gravity Fed gun (Devilbiss Model #FLG-3 mfd in Paipei Area of Taiwan). Side A and Side B were mixed together first, then 20% of the volume of the combined mixed Side A and Side B in the form of a non-VOC solvent was added and mixed into the blend. The mixed resin and non-VOC solvent blend was then poured into the cup. The cup was then affixed to the gun at the designated place. The coating material was sprayed using a 1.4 mm tip at 40 psi to form a polyurea coating on the surface. The coating wet out the surface and self-leveled to form the final protective coating.

TABLE 2

| Trade Name | Manufacturer | % of Side | Generic Name |
|---|---|---|---|
| Side A | | | |
| N3600 | Bayer | 64.25% | Aliphatic Polyioscyanate based Trimer |
| Airthane API-470 | Coim | 23.68% | Aliphatic Polyioscyanate based Trimer |
| Propylene Carbonate | Huntsman | 12.06% | Carbonate Ester Reactive Diluent |
| | | 100.00% | |
| Side B | | | |
| NH1520 | Bayer | 25.24% | Aspartic Ester Amine |
| NH1420 | Bayer | 39.79% | Aspartic Ester Amine |
| Vestamine A139 | Evonik/Degussa | 24.17% | Polyisocyanate Crosslinker |
| 1,4-Butanediol | Lyondell | 4.17% | Isomeric Reactive Diluent |
| Incozol 2 | Incorez | 2.14% | Mono Oxazolidine Moisture Scavenger |
| Perenol E8/Efka 2722 | Cognis/BASF | 1.07% | Air Relaease Agent |
| Fumed Silica | Evonik | 2.91% | Anti-Sag Additive |
| SIA 0591.0 | Gelest | 0.50% | Organosilane |
| | | 100.00% | |

### Example 6

The coating of Table 3 below was applied to a surface using a HVLP (High Volume Low Pressure) Gravity Fed gun as as was used in Example 5. Side A and Side B were mixed together first, then 30% of the volume of the combined mixed Side A and Side B in the form of non-VOC solvents were added and mixed into the blend. The mixed resin and non-VOC solvent blend was then poured into the cup. The composition of the non-VOC blend was 50% acetone and 50% tertiary butyl acetate (t-BAC) by volume. The cup was then affixed to the gun at the designated place. The coating material was sprayed using a 1.8 mm tip at 40 psi and subsequently using a 2.2 mm tip at 23 psi to form a polyurea coating on the surface. The coating wet out the surface and self-leveled to form the final protective coating

TABLE 3

| Trade Name | Manufacturer | % of Side | Generic Name |
|---|---|---|---|
| Side A | | | |
| Tolonate HDT LV2 | Perstorp | 64.25% | Aliphatic Polyioscyanate based Trimer |
| Airthane API-470 | Coim | 20.83% | Aliphatic Polyioscyanate based Trimer |
| Propylene Carbonate | Huntsman | 14.92% | Carbonate Ester Reactive Diluent |
| | | 100.00% | |
| Side B | | | |
| NH1520 | Bayer | 25.21% | Aspartic Ester Amine |
| NH1420 | Bayer | 39.85% | Aspartic Ester Amine |
| Vestamine A139 | Evonik/Degussa | 24.15% | Polyisocyanate Crosslinker |
| 1,4-Butanediol | Lyondell | 4.16% | Isomeric Reactive Diluent |
| Incozol 2 | Incorez | 2.14% | Mono Oxazolidine Moisture Scavenger |
| Efka 2723 | BASF | 1.07% | Air Relaease Agent |
| Fumed Silica | Evonik | 2.92% | Anti-Sag Additive |
| SIA 0591.0 | Gelest | 0.50% | Organosilane |
| | | 100.00% | |

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present disclosure. However, it should be recognized that the present disclosure can be practiced without resorting to the details specifically set forth. In other instances, well known processing structures have not been described in detail, in order not to unnecessarily obscure the present disclosure.

What is claimed is:

1. A protective coating comprising:
a polymeric film formed from a liquid applied coating having 100% solids and having zero solvents and zero volatile organic compounds, wherein the protective film is transparent to visible light.

2. A protective coating comprising:
a polymeric film formed from a liquid applied coating having 100% solids and having zero volatile organic compounds, wherein the protective film is transparent to visible light.

3. The protective coating of any of claim 1 or 2, wherein the liquid applied coating comprises two or more liquid components that are mixed before being applied to a surface and cured to form a solid coating after application to the surface.

4. The protective coating of claim 3, wherein the liquid applied coating is applied by casting onto the surface after mixing and spread on the surface to a final desired thickness.

5. The protective coating of any of claim 1 or 2 wherein the liquid applied coating is a polyurea or polyurethane, or a hybrid polyurea-polyurethane.

6. The protective coating of any of claim 1 or 2, wherein the liquid applied coating comprises dendrimers or hyperbranched polyol or polyamine raw materials.

7. The protective coating of any of claim 1 or 2, wherein the liquid applied coating contains no polyaspartic amines.

8. A method of forming a protective coating comprising the steps of
applying a liquid applied coating having 100% solids and having zero solvents and zero volatile organic compounds.

9. A method of forming a protective coating comprising the steps of
applying a liquid applied coating having 100% solids and having zero volatile organic compounds.

10. The method of any of claim 8 or 9, wherein the liquid applied coating is applied by casting, brushing, or rolling.

11. The method of any of claim 8 or 9, further comprising a step of mixing two or more liquid components before applying the liquid applied coating to a surface.

12. The method of claim 11, further comprising the step of curing the liquid applied coating to form a solid coating after applying the liquid applied coating to the surface.

13. The method of claim 12, wherein the curing step is performed at a temperature greater than ambient temperature.

14. The method of claim 13, wherein the curing step is performed at a temperature of from 130° F. to 150° F.

15. The method of claim 13, further comprising the step of abrading or buffing an edge of the coating to provide a gradual reduction of the thickness of the coating from a thickness greater than 1 mil to a thickness less than 1 mil.

16. The method of any of claim 8 or 9, wherein the liquid applied coating is applied by spraying using a high volume low pressure gun or similar non-mixing spray equipment.
